(19) United States
(12) Patent Application Publication
(10) Pub. No.: US 2018/0137520 A1
(43) Pub. Date: May 17, 2018

(54) REAL TIME SITUATION DETECTION ACROSS SYSTEMS

(71) Applicant: SAP SE, Walldorf (DE)

(72) Inventor: Olaf Schmidt, Walldorf (DE)

(21) Appl. No.: 15/352,032

(22) Filed: Nov. 15, 2016

(51) Int. Cl. G06Q 30/02; G06Q 50/00; G06N 99/00

(52) U.S. Cl. CPC G06Q 30/0201; G06N 99/005; G06Q 50/01

(57) ABSTRACT

A data connection is configured to each of a plurality of data platforms. Each data platform provides situational analysis data. The plurality of data platforms includes one or more external, publicly-available data platforms and one or more internal, private data platforms. A condition and associated criteria are defined for detecting a situation based on data received from two or more of the plurality of data platforms. One or more actions corresponding to the condition are defined. The actions are to be performed when the condition is satisfied. Data associated with the plurality of data platforms is received using the configured data connections. A determination is made that the condition has been satisfied based on a determined match between the received data and the associated criteria. The defined one or more actions corresponding to the condition are performed.

### BACKGROUND

Social media allows users, who may be individuals or organizations, to create, share, and exchange information in a virtual community or network. Social media data can include posts by users that have been shared by the user with other users in the user's virtual network. Sentiment analysis can be performed on social media data. For example, natural language processing, text analysis, and computational linguistics can be performed on social media posts of a user to determine an attitude (for example, positive or negative) of the user with respect to a particular topic.

### SUMMARY

The present disclosure describes methods and systems, including computer-implemented methods, computer program products, and computer systems for real time situation detection across systems.

In an implementation, a data connection is configured to each of a plurality of data platforms. Each data platform provides situational analysis data. The plurality of data platforms includes one or more external, publicly-available data platforms and one or more internal, private data platforms. A condition and associated criteria are defined for detecting a situation based on data received from two or more of the plurality of data platforms. One or more actions corresponding to the condition are defined. The actions are to be performed when the condition is satisfied. Data associated with the plurality of data platforms is received using the configured data connections. A determination is made that the condition has been satisfied based on a determined match between the received data and the associated criteria. The defined one or more actions corresponding to the condition are performed.

The above-described implementation is implementable using a computer-implemented method; a non-transitory, computer-readable medium storing computer-readable instructions to perform the computer-implemented method; and a computer system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, social media and other types of data can be monitored in real time. Second, situation detection can be performed in real time using data obtained from multiple data platforms. Third, situation detection can be automatically refined over time. Fourth, one or more users or systems can be automatically notified in response to detection of a situation based on data from multiple data platforms. Fifth, real time and historical data related to situation detection can be presented to users for situation monitoring and investigation. Sixth, retrieved data can be stored as historical data in a repository, and the historical data can be used for offline analysis and machine learning in order to automatically refine extraction criteria and do detect additional relevant information. Seventh, open APIs (Application Programming Interfaces) can be provided to enable integration of additional extraction methods for new external data sources. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level architectural block diagram illustrating an example distributed computing system (EDCS) for real time situation detection across systems, according to an implementation.

FIG. 2 illustrates an occurrence of an example situation, according to an implementation.

FIG. 3 is another high-level architectural block diagram illustrating another example distributed computing system (EDCS) for real time situation detection across systems, according to an implementation.

FIG. 4 illustrates an example situation dashboard, according to an implementation.

FIG. 5 illustrates an example tag cloud, according to an implementation.

FIG. 6 is a map that illustrates information related to users expressing sentiment towards a topic associated with a situation rule, according to an implementation.

FIG. 7 is a flowchart of an example method for real time situation detection across systems, according to an implementation.

FIG. 8 is a block diagram of an exemplary computer system used to provide computational functionalities associated with described algorithms, methods, functions, processes, flows, and procedures for real time situation detection across systems as described in the instant disclosure, according to an implementation.

Like reference numbers and designations in the various drawings indicate like elements.

### DETAILED DESCRIPTION

The following detailed description describes real time situation detection across systems and is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

Social media data from social media websites, blogs, and other sources can be analyzed to support business decisions. A social media analyzer can analyze, in real time, large volumes of social media data in a variety of formats, to extract valuable business information from the social media data. For example, social media data can be analyzed to determine customer sentiment about a product or a topic of interest. The determined customer sentiment can be used to support marketing and customer service activities, for example.

Social media data can include information that is not found in other sources. For example, customers who are dis-satisfied with a product may communicate frustrations on social media before contacting the company associated with the product or opening a ticket with the company's technical support system. A company can respond more quickly to a negative situation (for example, a system being down or compromised) if they are able to detect user posts in social media that are directed to the negative situation. Responding more quickly can enable the company to resolve the problem before more users become dis-satisfied.

More generally, a situation detector can analyze data, in real time, from social media systems and/or other types of systems to detect pre-defined situations. The situation detector can identify an instance of a configured situation that has been defined using a set of rules. The situation detector can notify registered responsible users and/or perform other actions upon detection of a pre-defined situation. A situation can relate to one or more of social media postings, financial data conditions, conditions related to sensors which can be used for predictive maintenance, etc.

An entity or person who is interested in detecting the occurrence of a situation that is indicated by social media and possibly other data can define a set of one or more rules which describe one or more conditions that indicate the occurrence of the situation. A condition can be the presence of at least a threshold number of occurrences of one or more keywords in one or more social media systems in a certain period of time, for example. For instance, a condition can be expressed as at least a threshold number of co-occurrences of a product name keyword and a negative sentiment keyword on social media and news blog sources. As another example, a condition can be a compound condition for which a first condition occurs in a first system (for example, a first social media system) and a second condition occurs in a second system (for example, a second social media system or some other type of system, such as a financial data system, weather data system, geo location data system, sensor data system, an on-premise system, etc.). Conditions can be expressed using keywords, hashtags, geographical information, user characteristics, and other elements.

The situation detector can automatically harvest social media data and other types of data and can analyze the harvested data to detect whether the data matches any pre-defined situations. If a situation is detected, the situation detector can automatically perform or cause to perform one or more pre-defined actions. A pre-defined action can be associated with a pre-defined situation and can be performed when the situation is detected. Actions can include the automatic notification of one or more users (for example, using an electronic message), an automatic post to a social media platform, the performing of a predefined process, an update to a user interface (for example, a monitoring dashboard), or some other type of action.

A company can use a dashboard, for example, for monitoring of situations that are of interest to a company. A company can configure a set of situation rules (for example, definitions) for suppliers, for example, to detect when negative sentiment is expressed on social media or other sources about any of a set of suppliers that are associated with the company. A dashboard can be configured to present information related to any social media or other data that has been detected to match any of the situation rules for the suppliers. The company may want to be notified, for example, if negative public sentiment or bad publicity occurs related to a particular supplier for the company, so that the company can decide whether to maintain a relationship with the particular supplier, since the company may not want to be associated with a supplier who has a bad reputation.

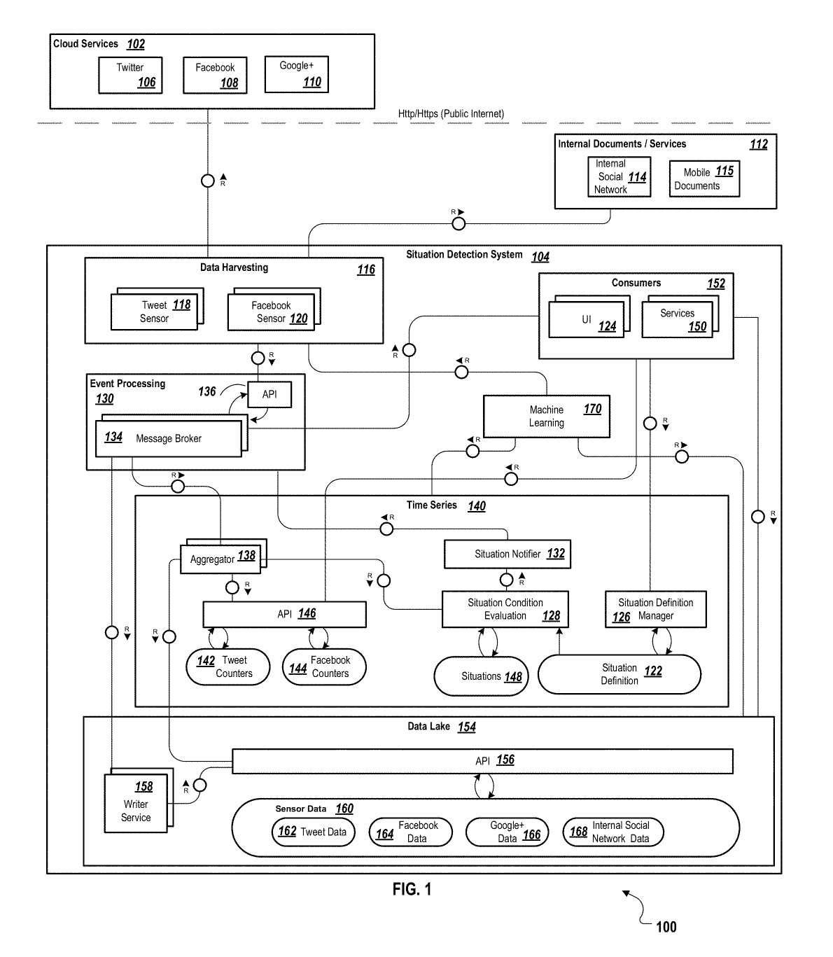

FIG. 1 is a high-level architectural block diagram illustrating an example distributed computing system (EDCS) 100 for real time situation detection across systems, according to an implementation. A set of cloud services 102 are accessible over one or more networks (for example, the Internet) by a situation detection system 104. The cloud services 102 include example first, second, and third social network platforms 106, 108, and 110 (for example, TWITTER, FACEBOOK, GOOGLE+). The cloud services 102 can include other social network platforms (for example, blogs), and other types of cloud services (for example, a weather data service, a financial data service, a news service, or any other type of service). The situation detection system 104 also has access to internal documents/services 112. The internal documents/services 112 can include an internal social network platform 114 for use within an organization, mobile documents 115, or other types of internal data sources or services. The mobile documents 115 can be, for example, documents that can be stored and shared in an organizational infrastructure that enables access from various devices (mobile, tablets, desktop, etc.). The cloud services 102 and the internal documents/services 112 can be referred to data platforms.

A data harvesting component 116 can receive data from the cloud services 102 and the internal documents/services 112. A sensor component (for example, a tweet sensor 118, a FACEBOOK sensor 120, a GOOGLE+ sensor (not shown)) can be included in the data harvesting component 116 for each service in the cloud services 102 and each service or document in the internal documents/services 112. The data harvesting component 116 can be configured so that additional types of sensors can be added that connect to other types of data. Each sensor can be configured to connect to and receive data from a respective service or document. A sensor in the data harvesting component can connect to a respective service using an API (Application Programming Interface) provided by the service, for example.

An API provided by a respective service can enable a sensor to retrieve all data that is associated with a set of one or more keywords provided by the sensor, for example. The keywords can be associated with a situation definition stored in a situation definitions store 122. The situation definition can be a definition defined by a user using a user interface 124. A situation definition manager 126 can provide user interface elements to be presented in the user interface 124 that enable a user to define a situation that can be detected by a situation condition evaluation component 128 based on analyzing data harvested by the data harvesting component 116 and further processed by an event processing component 130 (described in more detail below). In an example, a domain expert or another user can use the user interface 124 to define a situation. The situation definition manager 126 can create the situation definition using user input received from the user interface 124 and store the situation definition in the situation definitions store 122 (for example, as one or more configuration files).

A situation definition typically includes one or more conditions and associated criteria for detecting a situation based on data received from one or more data platforms (for example, one or more of the cloud services 102 and the internal documents/services 112). A situation definition can also define one or more actions corresponding to the condition to perform when the condition is satisfied. The actions can include, for example, generating an alert, updating a user interface, sending an electronic notification, or automatically performing a pre-defined computer-implemented process.

A condition can be that a data platform has provided certain types of kinds of data. For example, that a post or a threshold number of posts that include one or more specified keywords has been posted to a social media platform within a particular time period. As another example, a condition can be at least a threshold amount of increase or decrease in particular types of social media activity occurring on one or more social media platforms within a particular time period. As yet another example, a condition can be that one or more key users have made social media postings about a particular topic. In typical implementations, a social media expert can define a condition by identifying key users who have expertise in and/or frequently comment about the particular topic.

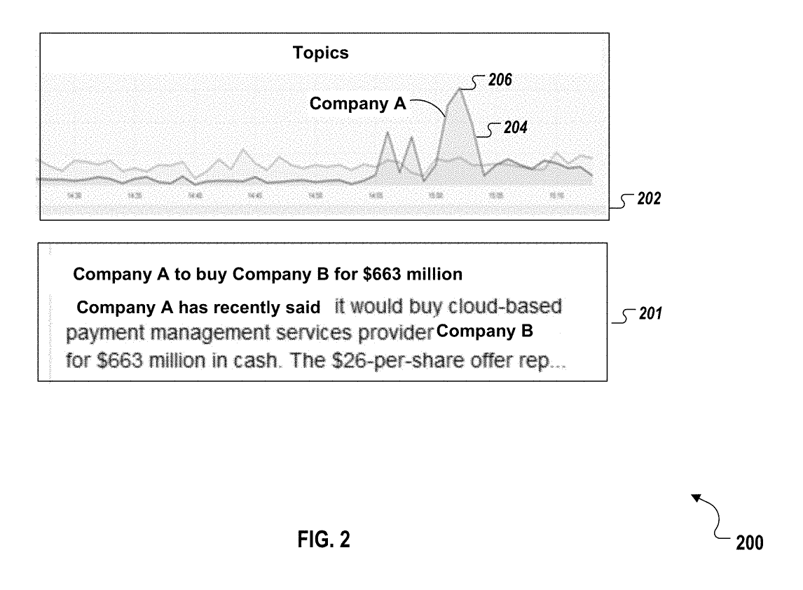

A situation definition can also include a compound condition that includes multiple conditions that are combined using Boolean logic (for example, AND, OR, NOT operators). For example, a condition can be that at least a threshold number of social media posts including a first keyword or a second keyword have occurred on both a first social media platform and on a second social media platform. A situation definition can also include a compound condition that includes a first condition occurring on a first type of data platform and a second condition occurring on a second type of data platform, as described below for FIG. 2.

FIG. 2 illustrates an occurrence of an example situation 200, according to an implementation. The example situation is illustrated by an example news posting 201 and a corresponding social media effect illustrated by a graph 202. The news posting 201, which may be a social media post, a blog post, a news article, or some other type of posting, indicates that a first company (“Company A”) has stated an intention to buy a second company (“Company B”). The graph 202 includes plotting of social media post counts that refer to various companies, including a line 204 that represents social media post counts for the first company. A peak 206 in the line 204 corresponds to a time period shortly after the posting of the news posting 201. The graph 202 may be included in a dashboard, which allows a user of the dashboard to view recent social media post counts related to the first company and other companies (or topics) of interest.

An entity, such as the first company, a competitor of the first company, or an entity otherwise interested in the first company (for example, the second company), may have defined, in association with a situation detection system, a situation definition that specifies that the entity is to be notified if more than a threshold number of social media posts related to the first company occur in a particular time period (for example, one hour, one day, one week, etc.). As another example, the entity may have defined a situation definition that specifies that the entity is to be notified when an increase of at least a threshold amount or percent of social media posts related to the first company occurs. The notification can include recently extracted social media or news posts related to the first company, such as the news posting 201.

As yet another example, the entity may have defined a situation definition that specifies that the entity is to be notified when more than a threshold number of social media posts related to the first company and more than a threshold number of news stories about the first company on a set of one or more predefined news sites both occur in a particular time period. As still another example, the entity may have defined a situation definition that specifies that the entity is to be notified when more than a threshold number of social media posts for the company have occurred within a given hour and the stock price of the company changes (for example, increases or decreases) by at least a threshold amount.

Referring again to FIG. 1, a situation definition can be based on a query that returns a set of data to be used in the definition. For example, and as described above, a company can create a situation definition to detect when negative sentiment is expressed on social media or other sources about any of a set of suppliers that are associated with the company. The situation definition can include a query to retrieve a list of suppliers for the company, such as from a database included in the local documents/services 112 or some other data source. For example, a list of suppliers can be automatically extracted from contracts in an on-premises data base and sorted according to business value of associated contracts, with only suppliers having a contract business value greater than a threshold used in a situation definition.

As another example, a situation definition can include a query that identifies a top set of suppliers and a situation definition can be created that specifies that a business manager is to be notified if a stock price of a top supplier decreases by at least a threshold percentage. The business manager may want to be notified of financial issues related to top suppliers, for example. As yet another example, a situation definition can include a query that identifies whether an internal system includes activities that are overdue or soon to be due. An action can be configured for the situation definition to display social media posts and financial data for a corresponding contract partner for any overdue or soon to be due activities. The social media posts and financial data can be shown in a dashboard, for example, as described in more detail below. In general, a situation definition can include conditions that relate to any combination of internal and external data.

After being defined, a situation rule can be published. A situation notifier 132 can send a message to the event processing component 130 that describes data to be harvested by the data harvesting component 116 and used by the situation condition evaluation component 128 to determine whether a condition has occurred. The event processing component 130 includes a message broker 134. The message broker 134 can include a set of queues, one queue for each type of data harvested by the data harvesting component 116, for example. The data harvesting component 116 can send harvested data to respective queues using an API 136 associated with the message broker 134.

In some implementations, the event processing component 130 performs relevance analysis on data obtained by the message broker 134 to determine whether harvested data actually matches situation definition information received from the situation notifier 132. For example, the data harvesting component 116 may request data from the cloud services 102 and/or the internal documents/services 112 using a simple keyword matching request. The event processing component 130 can perform semantic analysis on the harvested data that is more detailed than simple keyword matching. If data is determined to be relevant, it can be placed (or maintained) in the message queues of the message broker 134. A matching item of data can be annotated in a respective message queue with an identifier of an associated matching situation definition.

The message broker 134 can provide a publishing/subscription mechanism. A component, such as an aggregator 138, can subscribe to a particular message queue of the message broker 134. Multiple aggregators 138 can exist, such as one for each type of data harvested by the data harvesting component 116. Each aggregator 138 can subscribe to a particular message queue that will publish messages including harvested data of a particular type.

Each aggregator 138 can, upon receiving a message from a message queue of the message broker 134, increment a corresponding counter stored in a time series database 140. A counter can exist for each type of condition included in a situation definition which relates to a count of a certain type of data. For example, a situation definition can include a condition relating to a number of social media posts for a given topic on a particular platform in a given time period. A “tweet” counter 142 can be established in the time series database 140 for each condition that relates to counting a certain type of tweet. Similarly, a FACEBOOK counter 144 can be established in the time series database 140 for each condition that relates to counting a certain type of FACEBOOK post or activity. A respective tweet counter 142 or FACEBOOK counter 144 can be incremented by a corresponding aggregator 138 when a message corresponding to a particular condition associated with the respective counter is received. The time series database 140 can provide an API 146 for incrementing and reading the tweet counter 142, the FACEBOOK counter 144, and other counters, for example.

The time series database 140 can provide various features with respect to storing and querying data with respect to time. The situation condition evaluation component 128 can, for example, run queries against the data stored in the time series database 140 to determine whether the condition(s) associated with a situation definition have occurred. Queries can be performed for time windows, sliding time windows, etc., which can facilitate queries that correspond to a situation condition detection (for example, queries such as “have there been at least one hundred social media posts for topic X in the past hour?” can be submitted to the time series database 140). The time series database 140 can store data in an efficient manner for purposes of doing such time-related queries. The time series database 140 can provide support for visualization of data with respect to time, which can be displayed on user interfaces (for example, dashboards), as described below, when situation detection has occurred.

The situation condition evaluation component 128 can, such as by querying the time series database 140, determine that the condition(s) associated with a situation definition have been satisfied. As another example, an aggregator 138 can be configured to automatically notify the situation condition evaluation component 128 that amounts of certain types of data have met certain threshold(s). The situation condition evaluation component 128 can, in response to determining or being notified that a situation has occurred, instantiate a runtime representation 148 of a corresponding situation definition 122.

The runtime representation 148 can be used, for example, for performing any actions that have been defined to occur in response to detection of the situation. As described above, an action can be to update a user interface (for example, the user interface 124 or some other user interface), notify one or more users, or perform a specified process. As another example, a notification can be sent to one or more other services 150 or other systems. The user interface 124 and the services 150 can be referred to as consumers 152 (for example, consumers of information related to situation detection).

The message broker 134 and/or aggregators 138 can be configured to store data in a data lake 154 for historical analysis and/or investigation of situational data. For example, an aggregator 138 can use an API 156 of a writer service 158 to store data in a particular data area of a sensor data storage area 160. The sensor data storage area 160 can include a data area for each type of data harvested by the data harvesting component 116, for example. For instance, the sensor data area 160 includes a tweet data area 162, a FACEBOOK data area 164, a GOOGLE+ data area 166, and an internal social network data area 168.

Data in the sensor data area 160 can be used to support drill-down functionality on user interfaces, for example. For instance, a user interface can initially display time-based data that is stored in the time series database 140 to present an overview about received data related to situations. A user can select a displayed time-based item to view more information related to data collected at a particular time point. The user interface can be updated to show detailed information, including actual harvested data that corresponds to the condition. For example, a user can be first viewing a visualization graph, can select a peak of the graph, and can be shown more detailed data (for example, historical data retrieved from the data lake 154) that corresponds to the peak in the graph.

A machine learning component 170 can perform analysis on historical data included in the data lake 154 and time based data stored in the time series database 140 to learn about and refine situation definitions over time. For example, the machine learning component 170 can identify patterns or correlations in harvested data that might be used to better detect a particular situation. The machine learning component 170 can use artificial intelligence, natural language processing, and other machine learning approaches, which can be performed as periodic batch jobs, for example. Suggested refinements to situation definitions can be presented to administrators, for example, for acceptance consideration.

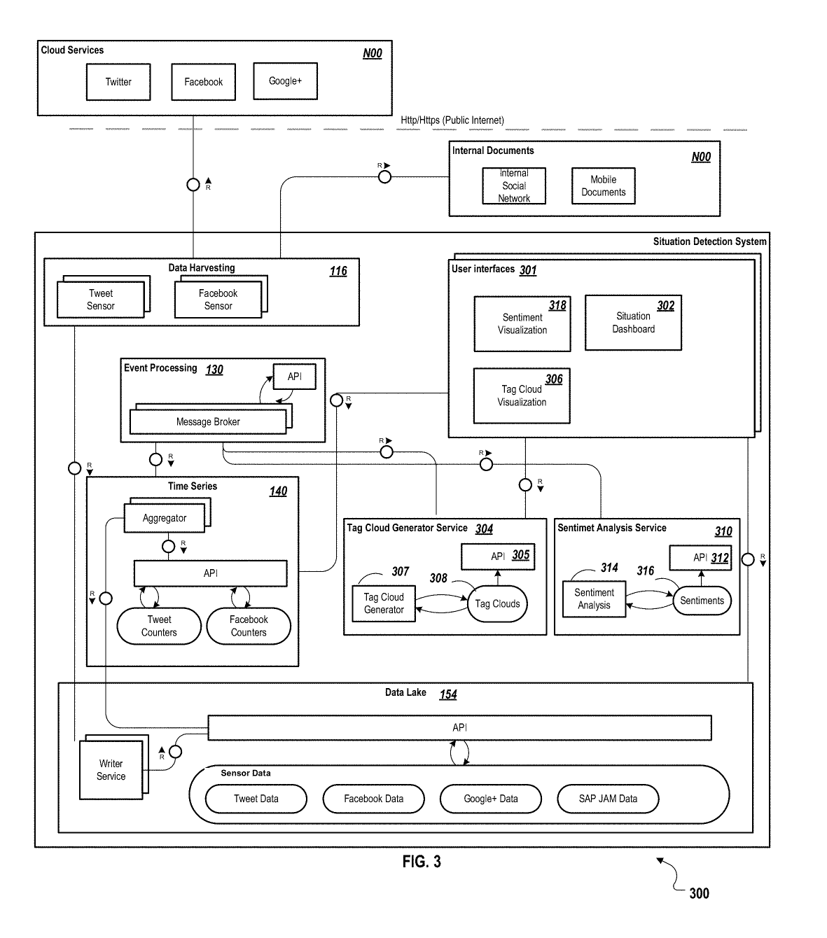

As described above, many (or all) components in the situation detection system 104 can be wrapped with an API. The use of APIs can enable modification, enhancement, or replacement of components while minimizing changes to connected components. Additional types of data for harvesting and situation detection can be easily added, for example. For example, the APIs of the system 100 can enable integration of additional external data sources which might provide relevant information (e.g. FOURSQUARE, PINTEREST, INSTAGRAM, etc.). As another example, several example user interfaces and consumers are described below with respect to FIG. 3. Other services and consumers are possible.

FIG. 3 is another high-level architectural block diagram illustrating another example distributed computing system (EDCS) 300 for real time situation detection across systems, according to an implementation. When a situation is detected, one or more user interfaces 301 can be updated. For example, a situation dashboard 302 can be updated to show information about the situation and to alert a user of the dashboard (for example, an administrator).

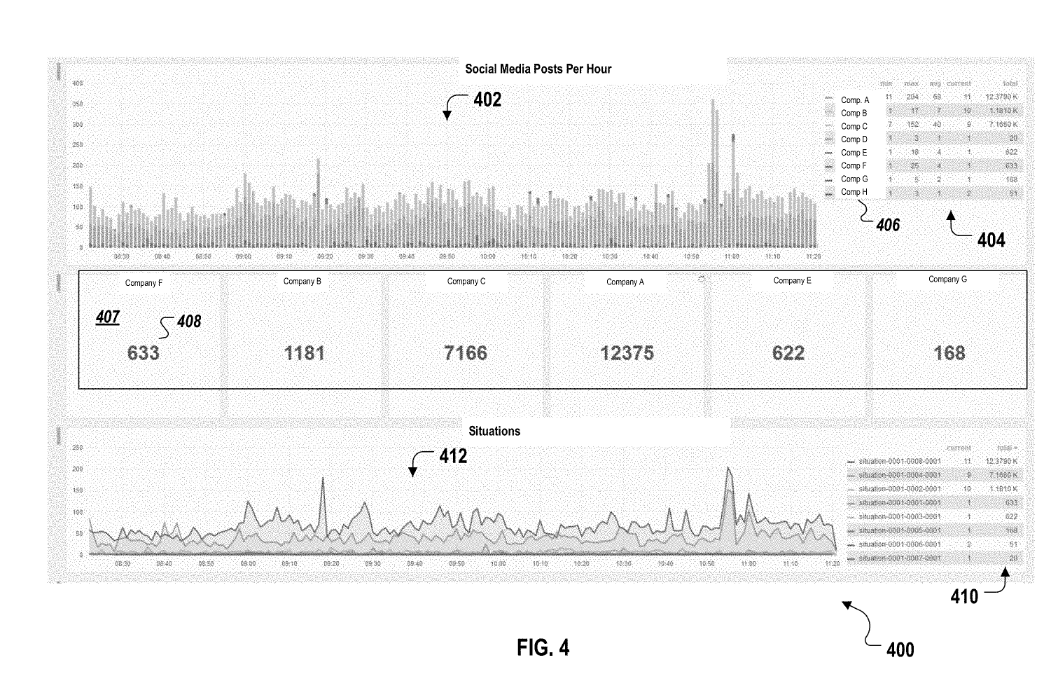

FIG. 4 illustrates an example situation dashboard 400, according to an implementation. The dashboard 400 can be used by an administrator, for example, to monitor activity related to a set of situations. The dashboard can be defined and configured by a domain expert who has knowledge about situations that are desired to be monitored. For example, the dashboard 400 can be configured to show social media activity (for example, social media post counts) related to a set of topics, such as a set of companies of interest. As another example, the monitored social media activity can be the presence of one or more of a set of keywords (for example, indicating negative sentiment, or some other type of topic) along with one or more keywords which indicate a company of interest (for example, a company name, product name, etc.). The companies of interest can include the company of the administrator, competitors, business partners, etc. The social media post counts can be for a particular social media platform or a set of social media platforms. Although social media post counts are shown, the dashboard 400 can also be used to show similar information for numbers of occurrences of any situation in a set of one or more predefined situations.

A top graph 402 shows social media post counts for each of several companies over a time period. Social media post counts for each company for each of several time points in the time period are plotted in the top graph 402 using, for example, a different color for each company. An overview area 404 indicates which colors correspond to which companies and also shows summary statistics for each company, such as a minimum, maximum, average, and current number of social media posts for each company in a recent time interval within the time period, as well as a total number of social media posts within the time period.

For example, an entry 406 for “Company H” indicates that a minimum of one and a maximum of three social media posts related to Company H have occurred in recent time intervals. The entry 406 also indicates that an average of one social media post has occurred related to Company H in recent time intervals, that two social media posts have occurred in the current time interval, and that a total of fifty social media posts have occurred in the time period. A time interval can be, for example, one minutes, ten minutes, or some other time interval. The time period may be, for example, the previous one hour, the previous two hours, etc. Other time intervals and time periods can be used.

A center area 407 provides a larger display of social media counts for each company within the time period. For example, a count 408 indicates that six hundred thirty-three social media posts have occurred for Company F in the time period. A lower right area 410 shows situation identifiers that correspond to situation rules that have been defined for the dashboard 400. A current situation instance count (for example, for the current time period) and a total situation instance count are displayed for each situation identifier in the lower right area 410. Situation instance counts per time interval are plotted on a graph 412. Items in the graph 412, the lower right area 410, the center area 407, and the overview area 402 can be selected by the administrator to cause presentation of further information or details related to the selected item, such as actual social media posts or data or other data associated with the occurrence of a situation.

Referring again to FIG. 3, a tag cloud generator service 304, which can be accessed using an API 305, can be used to generate one or more tag cloud visualizations 306 related to one or more situations. A tag cloud is a visualization of textual data. For example, a tag cloud generator 307 can generate one or more tag clouds 308 that illustrates how much data has been collected for various situation-related keywords.

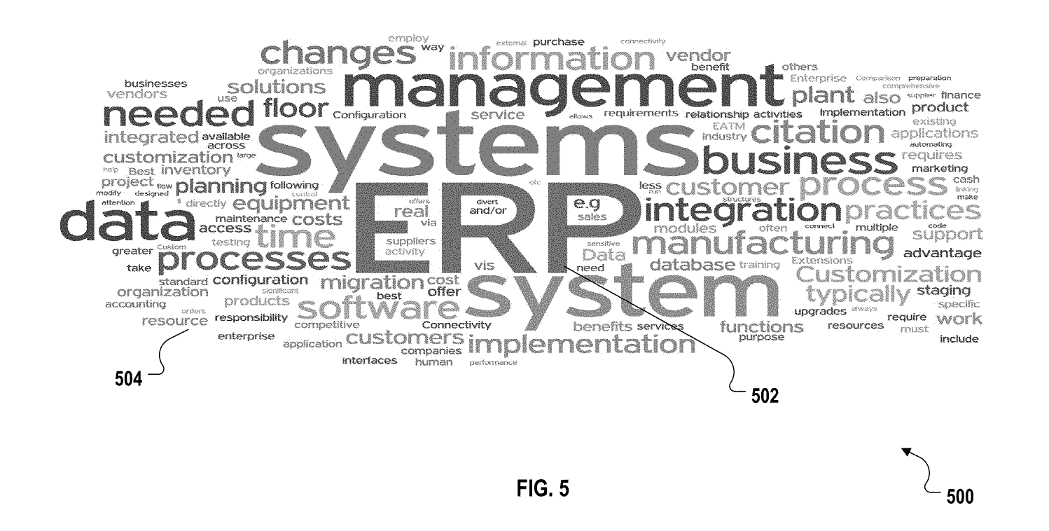

FIG. 5 illustrates an example tag cloud 500, according to an implementation. The tag cloud 500 is a visual representation of data received by the data harvesting component 116 described above with respect to FIG. 1. For example, the tag cloud 500 can include keywords (for example, one or more words) that are found in received data that match at least one situation condition. Keywords can be rendered in the tag cloud 500 using one or more styles which can represent, for example, how often a particular keyword has matched a situation condition in a particular time period. For example, a keyword that has matched a situation condition can be displayed in the tag cloud using a font size that represents how many times the keyword has appeared in the received data in a particular time period, with larger font sizes being used for larger number of appearances. For example, a keyword “ERP” (Enterprise Resource Planning) 502 appears in a larger font than a keyword “resource” 504.

Referring again to FIG. 3, a sentiment analysis service 310, which can be accessed using an API 312, can be used to analyze sentiment related to collected data. For example, a sentiment analysis component 314 can analyze data harvested by the data harvester component 112 that matches a situation to identify sentiment conclusions 316 from the harvested data. Sentiment conclusions can be presented using one or more sentiment visualizations 318. Sentiment analysis can be part of situation detection or can be a post-processing step after situation detection, for example.

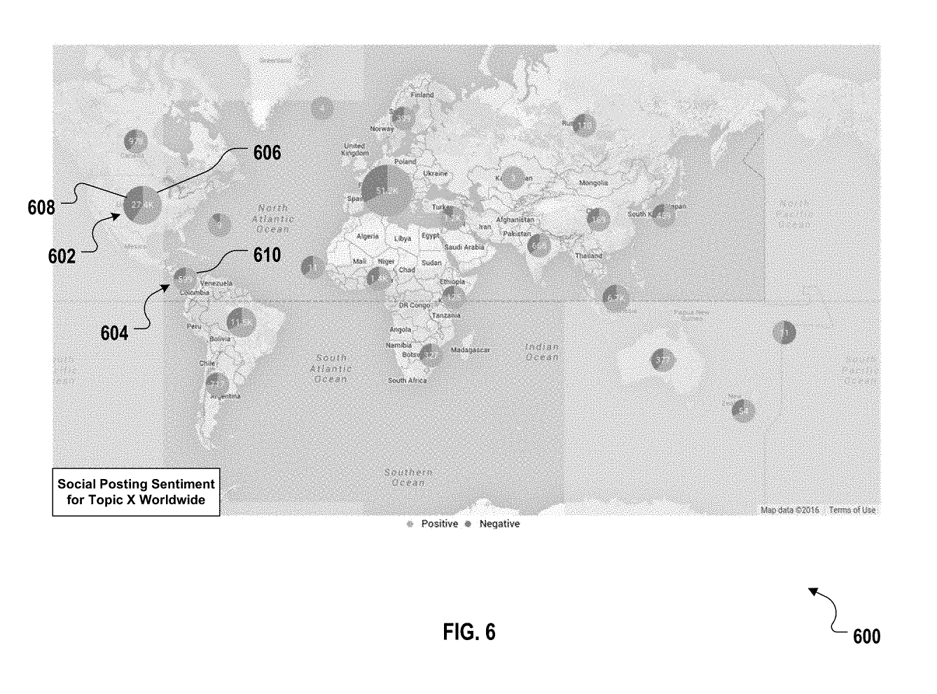

FIG. 6 is a map 600 that illustrates information related to users expressing sentiment towards a topic associated with a situation rule, according to an implementation. The map 600 includes various markers such as a marker 602 and a marker 604. Each marker on the map 600 is a pie chart that illustrates a number of users who have expressed sentiment for the topic (for example, a topic “X”) and a split between users who have expressed positive vs. negative sentiment. For example, the marker 602 indicates that 27,400 users have expressed sentiment for the topic in the United States, and that more United States users have expressed positive sentiment than those who have expressed negative sentiment (for example, as illustrated by a larger pie chart portion 606 as compared to a smaller pie chart portion 608). As another example, the marker 604 indicates that 599 users have expressed sentiment for the topic in Central America and that a higher proportion of Central American users have expressed positive sentiment than United States users (for example, as indicated by a pie chart portion 610 occupying a larger percentage of the marker 604 than the percentage of the marker 602 occupied by the pie chart portion 606).

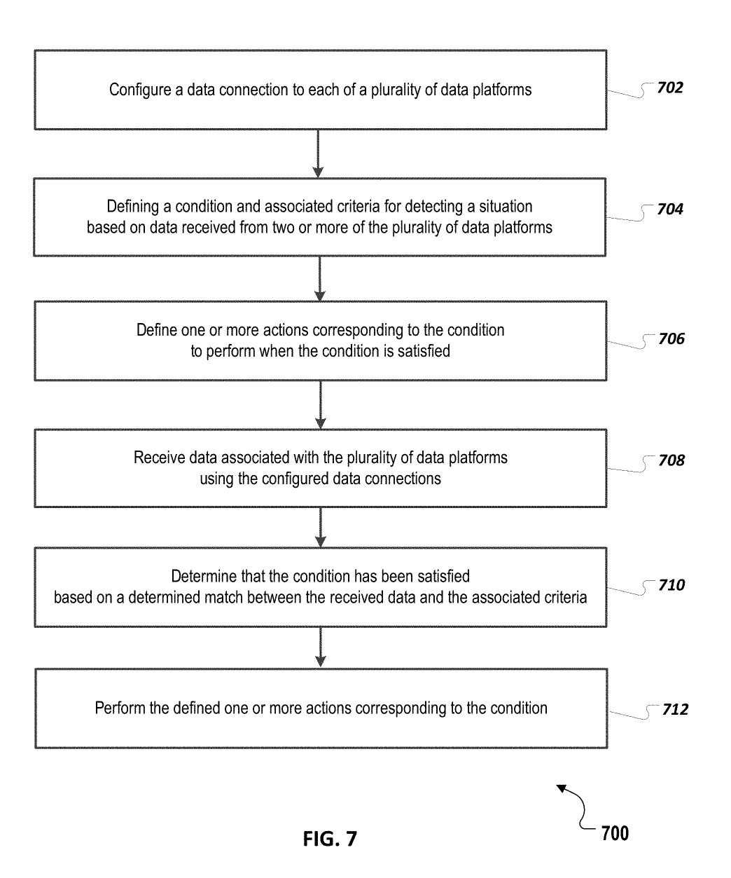

FIG. 7 is a flowchart of an example method 700 for real time situation detection across systems, according to an implementation. For clarity of presentation, the description that follows generally describes method 700 in the context of the other figures in this description. However, it will be understood that method 700 may be performed, for example, by any suitable system, environment, software, and hardware, or a combination of systems, environments, software, and hardware as appropriate. In some implementations, various steps of method 700 can be run in parallel, in combination, in loops, or in any order.

At 702, a data connection to each of a plurality of data platforms is configured. Each data platform provides situational analysis data. The plurality of data platforms includes one or more external, publicly-available data platforms and one or more internal, private data platforms. The external, publicly-available data platforms can include one or more social media platforms. From 702, method 700 proceeds to 704.

At 704, a condition and associated criteria for detecting a situation is defined based on data received from two or more of the plurality of data platforms. From 704, method 700 proceeds to 706. The associated criteria can include a first criterion associated with a first data platform and a second criterion associated with a second data platform.

At 706, one or more actions corresponding to the condition to perform when the condition is satisfied are defined. The defined one or more actions can include one or more of generating an alert, updating a user interface, sending an electronic notification, or automatically performing a pre-defined computer-implemented process. From 706, method 700 proceeds to 708.

At 708, data associated with the plurality of data platforms is received using the configured data connections. When the associated criteria include the first criterion associated with the first data platform and the second criterion associated with the second data platform, first data can be received from the first platform and second data can be received from the second platform. From 708, method 700 proceeds to 710.

At 710, a determination is made that the condition has been satisfied based on a determined match between the received data and the associated criteria. The first criterion and second criterion can be evaluated based on the received first data and the received second data. From 710, method 700 proceeds to 712.

At 712, the defined one or more actions corresponding to the condition are performed. An alert can be generated, a user interface can be updated, an electronic notification can be sent, or a pre-defined computer-implemented process can be automatically performed. From 712, method 500 stops.

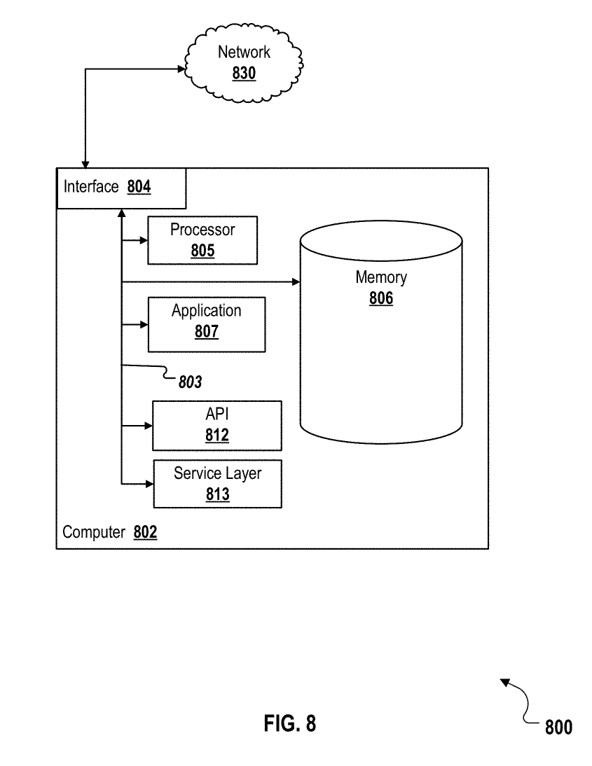

FIG. 8 is a block diagram of an exemplary computer system 800 used to provide computational functionalities associated with described algorithms, methods, functions, processes, flows, and procedures as described in the instant disclosure, according to an implementation. The illustrated computer 802 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 802 may comprise a computer that includes an input device, such as a keypad, keyboard, touch screen, or other device that can accept user information, and an output device that conveys information associated with the operation of the computer 802, including digital data, visual, or audio information (or a combination of information), or a GUI.

The computer 802 can serve in a role as a client, network component, a server, a database or other persistency, or any other component (or a combination of roles) of a computer system for performing the subject matter described in the instant disclosure. The illustrated computer 802 is communicably coupled with a network 830. In some implementations, one or more components of the computer 802 may be configured to operate within environments, including cloud-computing-based, local, global, or other environment (or a combination of environments).

At a high level, the computer 802 is an electronic computing device operable to receive, transmit, process, store, or manage data and information associated with the described subject matter. According to some implementations, the computer 802 may also include or be communicably coupled with an application server, e-mail server, web server, caching server, streaming data server, business intelligence (BI) server, or other server (or a combination of servers).

The computer 802 can receive requests over network 830 from a client application (for example, executing on another computer 802) and responding to the received requests by processing the said requests in an appropriate software application. In addition, requests may also be sent to the computer 802 from internal users (for example, from a command console or by other appropriate access method), external or third-parties, other automated applications, as well as any other appropriate entities, individuals, systems, or computers.

Each of the components of the computer 802 can communicate using a system bus 803. In some implementations, any or all of the components of the computer 802, both hardware or software (or a combination of hardware and software), may interface with each other or the interface 804 (or a combination of both) over the system bus 803 using an application programming interface (API) 812 or a service layer 813 (or a combination of the API 812 and service layer 813). The API 812 may include specifications for routines, data structures, and object classes. The API 812 may be either computer-language independent or dependent and refer to a complete interface, a single function, or even a set of APIs. The service layer 813 provides software services to the computer 802 or other components (whether or not illustrated) that are communicably coupled to the computer 802. The functionality of the computer 802 may be accessible for all service consumers using this service layer. Software services, such as those provided by the service layer 813, provide reusable, defined business functionalities through a defined interface. For example, the interface may be software written in JAVA, C++, or other suitable language providing data in extensible markup language (XML) format or other suitable format. While illustrated as an integrated component of the computer 802, alternative implementations may illustrate the API 812 or the service layer 813 as stand-alone components in relation to other components of the computer 802 or other components (whether or not illustrated) that are communicably coupled to the computer 802. Moreover, any or all parts of the API 812 or the service layer 813 may be implemented as child or sub-modules of another software module, enterprise application, or hardware module without departing from the scope of this disclosure.

The computer 802 includes an interface 804. Although illustrated as a single interface 804 in FIG. 8, two or more interfaces 804 may be used according to particular needs, desires, or particular implementations of the computer 802. The interface 804 is used by the computer 802 for communicating with other systems in a distributed environment that are connected to the network 830 (whether illustrated or not). Generally, the interface 804 comprises logic encoded in software or hardware (or a combination of software and hardware) and operable to communicate with the network 830. More specifically, the interface 804 may comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors may be used according to particular needs, desires, or particular implementations of the computer 802. Generally, the processor 805 executes instructions and manipulates data to perform the operations of the computer 802 and any algorithms, methods, functions, processes, flows, and procedures as described in the instant disclosure.

The computer 802 also includes a memory 806 that holds data for the computer 802 or other components (or a combination of both) that can be connected to the network 830 (whether illustrated or not). For example, memory 806 can be a database storing data consistent with this disclosure. Although illustrated as a single memory 806 in FIG. 8, two or more memories may be used according to particular needs, desires, or particular implementations of the computer 802 and the described functionality. While memory 806 is illustrated as an integral component of the computer 802, in alternative implementations, memory 806 can be external to the computer 802.

The application 807 is an algorithmic software engine providing functionality according to particular needs, desires, or particular implementations of the computer 802, particularly with respect to functionality described in this disclosure. For example, application 807 can serve as one or more components, modules, applications, etc. Further, although illustrated as a single application 807, the application 807 may be implemented as multiple applications 807 on the computer 802. In addition, although illustrated as integral to the computer 802, in alternative implementations, the application 807 can be external to the computer 802.

There may be any number of computers 802 associated with, or external to, a computer system containing computer 802, each computer 802 communicating over network 830. Further, the term “client,” “user,” and other appropriate terminology may be used interchangeably as appropriate without departing from the scope of this disclosure. Moreover, this disclosure contemplates that many users may use one computer 802, or that one user may use multiple computers 802.

Described implementations of the subject matter can include one or more features, alone or in combination.

For example, in a first implementation, a computer-implemented method includes: configuring a data connection to each of a plurality of data platforms, each data platform providing situational analysis data, the plurality of data platforms including one or more external, publicly-available data platforms and one or more internal, private data platforms; defining a condition and associated criteria for detecting a situation based on data received from two or more of the plurality of data platforms; defining one or more actions corresponding to the condition to perform when the condition is satisfied; receiving data associated with the plurality of data platforms using the configured data connections; determining that the condition has been satisfied based on a determined match between the received data and the associated criteria; and performing the defined one or more actions corresponding to the condition.

The foregoing and other described implementations can each optionally include one or more of the following features:

A first feature, combinable with any of the following features, wherein the defined one or more actions include one or more of generating an alert, updating a user interface, sending an electronic notification, or automatically performing a pre-defined computer-implemented process.

A second feature, combinable with any of the previous or following features, wherein the condition is automatically refined over time using machine learning.

A third feature, combinable with any of the previous or following features, wherein the external, publicly-available data platforms include one or more social media platforms.

A fourth feature, combinable with any of the previous or following features, wherein the condition is associated with multiple criteria.

A fifth feature, combinable with any of the previous or following features, wherein the associated criteria include a first criterion associated with a first data platform and a second criterion associated with a second data platform, receiving data comprises receiving first data from the first platform and second data from the second platform, and determining that the condition has been satisfied comprises evaluating the condition based on the received first data and the received second data.

A sixth feature, combinable with any of the previous or following features, comprising storing the received data for later historical analysis.

In a second implementation, a non-transitory, computer-readable medium stores one or more instructions executable by a computer system to perform operations. The operations comprise: configuring a data connection to each of a plurality of data platforms, each data platform providing situational analysis data, the plurality of data platforms including one or more external, publicly-available data platforms and one or more internal, private data platforms; defining a condition and associated criteria for detecting a situation based on data received from two or more of the plurality of data platforms; defining one or more actions corresponding to the condition to perform when the condition is satisfied; receiving data associated with the plurality of data platforms using the configured data connections; determining that the condition has been satisfied based on a determined match between the received data and the associated criteria; and performing the defined one or more actions corresponding to the condition.

The foregoing and other described implementations can each optionally include one or more of the following features:

A first feature, combinable with any of the following features, wherein the defined one or more actions include one or more of generating an alert, updating a user interface, sending an electronic notification, or automatically performing a pre-defined computer-implemented process.

A second feature, combinable with any of the previous or following features, wherein the condition is automatically refined over time using machine learning.

A third feature, combinable with any of the previous or following features, wherein the external, publicly-available data platforms include one or more social media platforms.

A fourth feature, combinable with any of the previous or following features, wherein the condition is associated with multiple criteria.

A fifth feature, combinable with any of the previous or following features, wherein the associated criteria include a first criterion associated with a first data platform and a second criterion associated with a second data platform, receiving data comprises receiving first data from the first platform and second data from the second platform, and determining that the condition has been satisfied comprises evaluating the condition based on the received first data and the received second data.

A sixth feature, combinable with any of the previous or following features, comprising storing the received data for later historical analysis.

In a third implementation, a computer system comprises a computer memory and a hardware processor interoperably coupled with the computer memory and configured to perform operations. The operations comprise: configuring a data connection to each of a plurality of data platforms, each data platform providing situational analysis data, the plurality of data platforms including one or more external, publicly-available data platforms and one or more internal, private data platforms; defining a condition and associated criteria for detecting a situation based on data received from two or more of the plurality of data platforms; defining one or more actions corresponding to the condition to perform when the condition is satisfied; receiving data associated with the plurality of data platforms using the configured data connections; determining that the condition has been satisfied based on a determined match between the received data and the associated criteria; and performing the defined one or more actions corresponding to the condition.

The foregoing and other described implementations can each optionally include one or more of the following features:

A first feature, combinable with any of the following features, wherein the defined one or more actions include one or more of generating an alert, updating a user interface, sending an electronic notification, or automatically performing a pre-defined computer-implemented process.

A second feature, combinable with any of the previous or following features, wherein the condition is automatically refined over time using machine learning.

A third feature, combinable with any of the previous or following features, wherein the external, publicly-available data platforms include one or more social media platforms.

A fourth feature, combinable with any of the previous or following features, wherein the condition is associated with multiple criteria.

A fifth feature, combinable with any of the previous or following features, wherein the associated criteria include a first criterion associated with a first data platform and a second criterion associated with a second data platform, receiving data comprises receiving first data from the first platform and second data from the second platform, and determining that the condition has been satisfied comprises evaluating the condition based on the received first data and the received second data.

A sixth feature, combinable with any of the previous or following features, comprising one or more instructions to store the received data for later historical analysis.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate. Thresholds used to make computational determinations can be statically, dynamically, or both statically and dynamically determined.

The methods, processes, logic flows, etc. described in this specification can be performed by one or more programmable computers executing one or more computer programs to perform functions by operating on input data and generating output. The methods, processes, logic flows, etc. can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
configuring a data connection to each of a plurality of data platforms, each data platform providing situational analysis data, the plurality of data platforms including one or more external, publicly-available data platforms and one or more internal, private data platforms;
defining a condition and associated criteria for detecting a situation based on data received from two or more of the plurality of data platforms;
defining one or more actions corresponding to the condition to perform when the condition is satisfied;
receiving data associated with the plurality of data platforms using the configured data connections;
determining that the condition has been satisfied based on a determined match between the received data and the associated criteria; and
performing the defined one or more actions corresponding to the condition.

2. The computer-implemented method of claim 1, wherein the defined one or more actions include one or more of generating an alert, updating a user interface, sending an electronic notification, or automatically performing a pre-defined computer-implemented process.

3. The computer-implemented method of claim 1, wherein the condition is automatically refined over time using machine learning.

4. The computer-implemented method of claim 1, wherein the external, publicly-available data platforms include one or more social media platforms.

5. The computer-implemented method of claim 1, wherein the condition is associated with multiple criteria.

6. The computer-implemented method of claim 5, wherein:
the associated criteria include a first criterion associated with a first data platform and a second criterion associated with a second data platform;
receiving data comprises receiving first data from the first platform and second data from the second platform; and
determining that the condition has been satisfied comprises evaluating the condition based on the received first data and the received second data.

7. The computer-implemented method of claim 1, further comprising storing the received data for later historical analysis.

8. A non-transitory, computer-readable medium storing one or more instructions executable by a computer system to perform operations comprising:
configuring a data connection to each of a plurality of data platforms, each data platform providing situational analysis data, the plurality of data platforms including one or more external, publicly-available data platforms and one or more internal, private data platforms;
defining a condition and associated criteria for detecting a situation based on data received from two or more of the plurality of data platforms;
defining one or more actions corresponding to the condition to perform when the condition is satisfied;
receiving data associated with the plurality of data platforms using the configured data connections;
determining that the condition has been satisfied based on a determined match between the received data and the associated criteria; and
performing the defined one or more actions corresponding to the condition.

9. The computer-readable medium of claim 8, wherein the defined one or more actions include one or more of generating an alert, updating a user interface, sending an electronic notification, or automatically performing a pre-defined computer-implemented process.

10. The computer-readable medium of claim 8, wherein the condition is automatically refined over time using machine learning.

11. The computer-readable medium of claim 8, wherein the external, publicly-available data platforms include one or more social media platforms.

12. The computer-readable medium of claim 8, wherein the condition is associated with multiple criteria.

13. The computer-readable medium of claim 12, wherein:
the associated criteria include a first criterion associated with a first data platform and a second criterion associated with a second data platform;
receiving data comprises receiving first data from the first platform and second data from the second platform; and
determining that the condition has been satisfied comprises evaluating the condition based on the received first data and the received second data.

14. The computer-readable medium of claim 9, further comprising one or more instructions to store the received data for later historical analysis.

15. A computer system, comprising:
a computer memory; and
a hardware processor interoperably coupled with the computer memory and configured to perform operations comprising:
configuring a data connection to each of a plurality of data platforms, each data platform providing situational analysis data, the plurality of data platforms including one or more external, publicly-available data platforms and one or more internal, private data platforms;
defining a condition and associated criteria for detecting a situation based on data received from two or more of the plurality of data platforms;
defining one or more actions corresponding to the condition to perform when the condition is satisfied;
receiving data associated with the plurality of data platforms using the configured data connections;
determining that the condition has been satisfied based on a determined match between the received data and the associated criteria; and
performing the defined one or more actions corresponding to the condition.

16. The computer system of claim 15, wherein the defined one or more actions include one or more of generating an alert, updating a user interface, sending an electronic notification, or automatically performing a pre-defined computer-implemented process.

17. The computer system of claim 15, wherein the condition is automatically refined over time using machine learning.

18. The computer system of claim 15, wherein the external, publicly-available data platforms include one or more social media platforms.

19. The computer system of claim 15, wherein the condition is associated with multiple criteria.

20. The computer system of claim 19, wherein:
the associated criteria include a first criterion associated with a first data platform and a second criterion associated with a second data platform;
receiving data comprises receiving first data from the first platform and second data from the second platform; and
determining that the condition has been satisfied comprises evaluating the condition based on the received first data and the received second data.
